(19) United States
(12) Patent Application Publication
(10) Pub. No.: US 2017/0234731 A1
(43) Pub. Date: Aug. 17, 2017

(54) METHOD FOR DETERMINING ABSORPTION BANDS

(71) Applicants: INSTITUT NATIONAL DE LA SANTE ET DE LA RECHERCHE MEDICALE (INSERM), Paris (FR); UNIVERSITE DE BORDEAUX, Bordeaux (FR)

(72) Inventors: Cyril PETIBOIS, Pessac (FR); Vladimir BOBROFF, Talence Cedex (FR); Adrien TRAVO, Talence Cedex (FR); Erik GOORMAGHTIGH, Bruzelles (BE)

(21) Appl. No.: 15/502,904

(22) PCT Filed: Aug. 11, 2015
(86) PCT No.: PCT/EP2015/068475

§ 371 Date: Feb. 9, 2017

(30) Foreign Application Priority Data
Aug. 20, 2014 (EP) 14306299.0

(51) Int. Cl. G01J 3/433; G01N 21/64; G01N 21/31

(52) U.S. Cl. CPC G01J 3/433; G01N 21/31; G01N 21/6486; G01N 2021/3196; G01J 2003/283

(57) ABSTRACT

The present invention concerns a method for determining at least one absorption band in a spectrum, the method at least comprising the steps of:—providing a measured absorption spectrum from the sample,—providing a calculation spectrum,—from the calculation spectrum, extracting at least one absorption band,—calculating a residual spectrum by removing each extracted absorption band from the calculation spectrum, testing whether a predefined stop criterion is fulfilled by the residual spectrum,—if the stop criterion is not fulfilled, using the residual spectrum as the calculation spectrum and iterating the extracting step, the forming step, the calculating step and the testing step, and—if the stop criterion is fulfilled, outputting each extracted absorption band.

### TECHNICAL FIELD OF THE INVENTION

The present invention concerns a method for determining at least one absorption band in a spectrum. The present invention also relates to a method for three-dimensional imaging a three-dimensional sample. The present invention also concerns the associated spectrometers and computer program products.

### BACKGROUND OF THE INVENTION

Biological samples are biological tissues comprising diverse cell populations and compounds. Each cell population exhibits specific metabolic and biochemical characteristics which are organized and/or distributed in three dimensions. Each compound influences the overall behavior of the analyzed tissues. Therefore, it is desirable to study the evolution of these compounds and the different cell populations of a biological sample in three dimensions.

To follow the evolution of tissue compounds, histopathology techniques are known. Histopathology refers to the microscopic examination of tissues in order to study the manifestations of disease. Specifically, in clinical medicine, histopathology refers to the examination of a biopsy or surgical specimen by a pathologist, after the specimen has been processed and histological sections have been placed onto glass slides. In contrast, cytopathology examines free cells or tissue fragments.

Immunohistochemistry and immunofluorescence are two widely used histopathology techniques.

Immunohistochemistry or IHC refers to the process of detecting labels—mostly antigens—in cells or interstitial chemicals of a tissue section by exploiting the principle of antibodies binding specifically to antigens in biological tissues. The procedure was conceptualized and first implemented by Dr. Albert Coons in 1941. Visualizing an antibody-antigen interaction can be accomplished in a number of ways. In the most common instance, an antibody is conjugated to an enzyme, such as peroxidase, that can catalyze a colour-producing reaction.

Alternatively, the antibody can also be tagged to a fluorophore, such as fluorescein or rhodamine. Such technique is called immunofluorescence or IF. This technique is thus a widely used example of immunostaining and a specific example of immunohistochemistry that makes use of fluorophores to visualize the location of the antibodies. Immunofluorescence can be used on tissue sections, cultured cell lines, or individual cells, and may be used to analyze the distribution of proteins, glycans, and small biological and non-biological molecules. Immunofluoresence can be used in combination with other, non-antibody methods of fluorescent staining, for example, use of DAPI to label DNA. Several microscope designs can be used for analysis of immunofluorescence samples; the simplest is the epifluorescence microscope, and the confocal microscope is also widely used. Various super-resolution microscope designs that are capable of much higher resolution can also be used.

However, immunohistochemistry and immunofluorescence are histopathology imaging techniques which do not provide access to the spatially ordered chemical and cell compounds within the analyzed tissue. Moreover, these techniques do not enable to provide a quantitative measurement of sample contents. These techniques are also limited in the number of analyzed compounds on a single sample due to the poor compatibility between labels.

Such quantitative and more global measurement of sample contents can notably be provided by spectroscopic techniques. By definition, spectroscopy is the study of the interaction between matter and radiated energy over a broad wavelength region. Thus, multiple experimental techniques are spectroscopic techniques. Infrared spectroscopy, Raman spectroscopy, mass-spectrometry, X-ray fluorescence are examples of spectroscopic techniques providing quantitative measurement of sample contents.

Recent initiatives have demonstrated that three-dimensional infrared imaging can be reconstructed by stacking two-dimensional images of tissue sections. An example of such technique is notably described in the article from B. R. Wood et al., whose title is “A three-dimensional multivariate image processing technique for the analysis of FTIR spectroscopic images of multiple tissue sections” and published in the review BMC Med Imaging 6 (12), 1 (2006).

It has also been proposed to co-add several view angles from the same sample volume for a tomographic reconstruction. This approach is notably developed in the article from M. C. Martin et al., whose title is “3D spectral imaging with synchrotron Fourier transform infrared spectro-microtomography” and published in the review Nat Methods 10 (9), 861 (2013).

The use of synchrotron radiation has been considered as a valuable alternative to the Globar sources for obtaining high signal/noise values, which limited the quantitative artifacts in three-dimensional reconstruction. Such idea is notably developed in the article from C. Petibois et al., whose title is “A bright future for synchrotron imaging” and published in the review Nat Photonics 3 (4), 179 (2009). This idea can also be found in the article from F. Jamme et al., whose title is “Synchroton infrared confocal microscope: Application to infrared 3D spectral imaging” and published in the review J Phys: Conf Series 425 (142002), 1 (2012).

However, the use of such techniques implies the use of radiation sources with relatively high power. Synchrotrons for X-ray fluorescence or ion sources for mass-spectrometry are examples of such radiation sources. The use of such power sources limits the development of the spectroscopic techniques in clinics. Notably, the synchrotron facility is not easily accessible which prevents considering using a technique implying a synchrotron radiation source. It must be also mentioned that such infrared source is not considered as stable enough to allow long-lasting spectral data acquisitions, which thus limits the capacity to analyze large tissue samples at high spectral and pixel resolutions.

Moreover, the detectors used in clinics are usually of small dimensions, thus restricting the applicability of imaging methods to small sample areas or volumes.

Additionally, such techniques remain poorly serviceable for end users who are not specialists of their utilization, i.e. for clinicians and biologists.

In addition, none of the above-mentioned techniques enable to achieve three-dimensional sample imaging at a large scale, that is, for instance, a volume of 1 cm³ for a biopsy of surgical exeresis.

In other fields, notably for gases, it is also known documents WO 2009/140492 A2 and US 2012/065948 A1 wherein it is aimed to detect chemical compounds.

### SUMMARY OF THE INVENTION

There is therefore a need for a method for determining absorption bands from covalent bonds of chemical species present in a sample that alleviates at least partly the above-mentioned defects.

To this end, it is proposed a method for determining at least one absorption band in a spectrum, a spectrum being the evolution of a absorption quantity with regards to a wavelength quantity in a predefined range of wavelength quantity, the absorption quantity being a quantity representative of the absorption and the wavelength quantity being a quantity representative of the wavelength, each absorption band being a mathematical distribution associated to at least one covalent bond of chemical species present in a sample, the mathematical distribution being characterized by mathematical parameters, the method at least comprising the steps of:
providing a measured absorption spectrum from the sample,
providing a calculation spectrum which is equal to the measured absorption spectrum,
from the calculation spectrum, extracting at least one absorption band,
forming an absorption band population by grouping each extracted absorption band,
calculating a residual spectrum by removing each extracted absorption band from the calculation spectrum,
testing whether a predefined stop criterion is fulfilled by the residual spectrum,
if the stop criterion is not fulfilled, using the residual spectrum as the calculation spectrum and iterating the extracting step, the forming step, the calculating step and the testing step, the extracted absorption band(s) at the end of the iterating step being different from the previously extracted absorption band(s), and
if the stop criterion is fulfilled, outputting each extracted absorption band.

With comparison to the document WO 2009/140492 A2, it should be emphasized that the present method applies to absorption band and not a single line (as it is the case in the context of gases). In addition, it is not mentioned in such document that the residual spectrum (in other words the error spectrum) is used to correct the generated bands and to generate new ones by using an iterative method.

Contrary to the document US 2012/065948 A1, the present method does determine absorption bands and does use the residual spectrum to correct the generated bands and to generate new ones by using an iterative method.

Such method therefore enables to improve the accuracy of the determination of the chemical species.

This is all the more interesting for biological sample. In usual conditions, biological samples are solid or liquid which renders the analysis of the content of a sample quite difficult. Notably, the method of documents WO 2009/140492 A2 and US 2012/065948 A1 would not be convenient for such use. [Please complete with other arguments which would prevent from the use of these documents in the biological context].

According to further aspects which are advantageous but not compulsory, the method for determining at least one absorption band associated to a covalent bond present in chemical species of a sample might incorporate one or several of the following features, taken in any admissible combination:
the sample is a biological sample.
the distribution profile is chosen among a Gaussian profile, a Lorentzian profile and a Voigt profile, the Voigt profile being characterized by a Gaussian proportion and a Lorentzian proportion.
a mathematical parameter is the position of the absorption band, the position being the wavelength quantity of the absolute maximum of absorption quantity of the considered absorption band.
a mathematical parameter is the width of the absorption band.
the extracting step comprises the steps of searching the absorption band(s) in the calculation spectrum, to obtain found absorption band(s), and deducing values to mathematical parameters of each found absorption band, to obtain deduced parameters.
the extracting step comprises carrying out a step chosen in the group consistingof obtaining the maxima of the calculation spectrum, calculating the first derivative of the absorption quantity with relation to the wavelength quantity, to obtain a first derivative of the calculation spectrum, calculating the second derivative of the absorption quantity with relation to the wavelength quantity, to obtain a second derivative of the calculation spectrum, and obtaining the minima of the second derivative of the calculation spectrum, the second derivative being the second derivative of the absorption quantity with relation to the wavelength quantity.
the extracting step further comprises curve-fitting each absorption band by using the deduced parameters of the absorption band and a distribution profile.
the stop criterion is chosen in a group consisting of:
   the integral of the absorption quantity in the residual spectrum over the predefined range of wavelength quantity is strictly inferior to the product of 1% with the integral of absorption quantity in the measured absorption spectrum over the predefined range of wavelength quantity.
the integral of the absorption quantity in the residual spectrum over the predefined range of wavelength quantity is strictly inferior to the product of 0.1% with the integral of absorption quantity in the measured absorption spectrum over the predefined range of wavelength quantity.
   the absolute value of the absorption quantity per wavelength quantity in the residual spectrum is strictly inferior to the product of 1% with the absolute value of absorption quantity per wavelength quantity in the measured absorption spectrum.
   the absolute value of the absorption quantity per wavelength quantity in the residual spectrum is strictly inferior to the product of 0.1% with the absolute value of absorption quantity per wavelength quantity in the measured absorption spectrum.
   the ratio between the absorption quantity in the residual spectrum and the absorption quantity in the measured absorption spectrum is strictly inferior to 1% in the predefined range of wavelength quantity,
   the ratio between the absorption quantity in the residual spectrum and the absorption quantity in the measured absorption spectrum is strictly inferior to 0.1% in the predefined range of wavelength quantity, and
   any combination of the previous stop criteria.
the method further comprises if the stop criterion is not fulfilled, a step of correcting each previously extracted absorption band by using the residual spectrum.
each absorption band has a position and a width with extremities, the correcting step comprising, for each extracted absorption band, determining the algebraic sign of the residual spectrum at the position of the considered absorption band and/or at the extremities of the width of the considered absorption band.
each absorption band has a position and a width with extremities, the correcting step comprising, for each extracted absorption band, analyzing the symmetry of the residual spectrum with relation to the position of each considered absorption band.
the stop criterion is fulfilled when using the residual spectrum as the calculation spectrum to iterate the extracting step, the forming step, the calculating step and the testing step, the previously determined bands parameters are not further modified and no new band is added to the previously obtained absorption band population.

It is also proposed a method for three-dimensional imaging a three-dimensional sample, the method comprising at least the step of dividing the three-dimensional sample in a plurality of two-dimensional samples, carrying out the method for determining at least one absorption band to each two-dimensional sample, the method being as described here above, to obtain at least one absorption band associated to at least one covalent bond for each two-dimensional sample, and reconstructing the three-dimensional sample by using the obtained absorption band for each two-dimensional sample.

It is also proposed a spectrometer comprising a radiation source, optics to transport the radiation emitted by the radiation source towards the sample, a sample holder, a detector and a calculator adapted to carry out a method as described here-above.

It also concerns a computer program product comprising a computer readable medium, having thereon a computer program comprising program instructions, the computer program being loadable into a data-processing unit and adapted to cause execution of a method as described here-above when the computer program is run by the data-processing unit.

### BRIEF DESCRIPTION OF THE DRAWINGS

The invention will be better understood on the basis of the following description, which is given in correspondence with the annexed figures and as an illustrative example, without restricting the object of the invention. In the annexed figures:

FIG. 1 is a schematic representation of a system and a computer program product, whose interaction enables to carry out a method for determining at least one absorption band in a spectrum,

FIG. 2 is a flowchart of an example of carrying out of a method for determining at least one absorption band in a spectrum,

FIG. 3 is a flowchart of another example of carrying out of the method for determining at least one absorption band,

FIG. 4 is a graph illustrating an absorbance spectrum, that is the evolution of the absorbance with the wavenumber,

FIG. 5 is a graph illustrating the evolution with the wavenumber of the second derivative of the absorbance with relation to the wavenumber,

FIG. 6 is a graph illustrating the evolution of the absorbance with the wavenumber and the different identified absorption bands in the absorbance spectrum, and

FIG. 7 is a schematic representation of a spectrometer.

### DETAILED DESCRIPTION OF SOME EMBODIMENTS

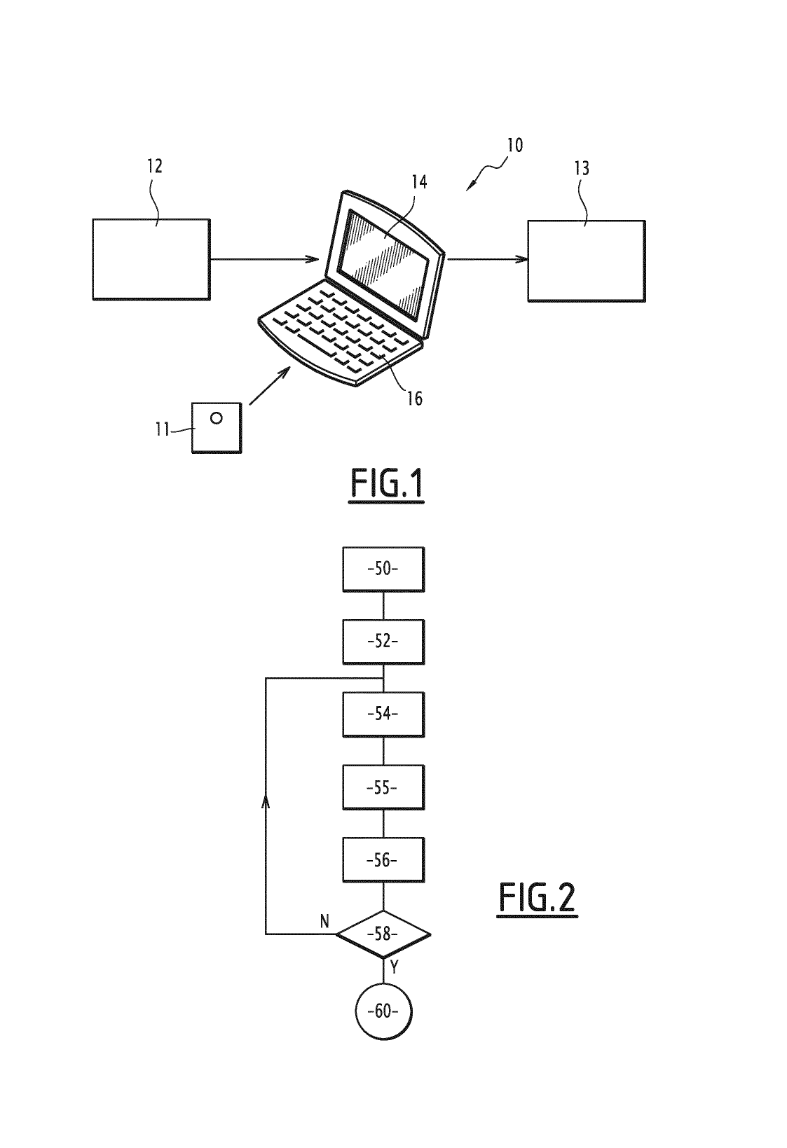

A system 10 and a computer program product 11 are represented in FIG. 1. The interaction between the computer program product 11 and the system 10 enables to carry out a method for determining at least one absorption band in a spectrum. This is symbolized in FIG. 1 by the two boxes 12 and 13. The first box corresponds to the input, which is, in this context, a spectrum. The second box corresponds to the output, which is, in this context, the absorption bands. In the remainder of the description, the method for determining at least one absorption band in a spectrum is named method for determining absorption bands.

System 10 is a computer. In the present case, system 10 is a laptop.

More generally, system 10 is a computer or computing system, or similar electronic computing device adapted to manipulate and/or transform data represented as physical, such as electronic, quantities within the computing system's registers and/or memories into other data similarly represented as physical quantities within the computing system's memories, registers or other such information storage, transmission or display devices.

System 10 comprises a processor, a keyboard 14 and a display unit 16.

The processor comprises a data-processing unit, memories and a reader adapted to read a computer readable medium.

The computer program product 11 comprises a computer readable medium.

The computer readable medium is a medium that can be read by the reader of the processor. The computer readable medium is a medium suitable for storing electronic instructions, and capable of being coupled to a computer system bus.

Such computer readable storage medium is, for instance, a disk, a floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

A computer program is stored in the computer readable storage medium. The computer program comprises one or more stored sequence of program instructions.

The computer program is loadable into the data-processing unit and adapted to cause execution of the method for determining absorption bands when the computer program is run by the data-processing unit.

Operation of the system 10 is now described in reference to the flowchart of FIG. 2, which illustrates an example of carrying out the method for determining absorption bands.

Each absorption band is a mathematical distribution associated to a covalent band of chemical species present in a sample.

By definition a covalent bond is a chemical bond that involves the sharing of electron pairs between atoms. The stable balance of attractive and repulsive forces between atoms when the atoms share electrons is known as covalent bonding. For many molecules, the sharing of electrons allows each atom to attain the equivalent of a full outer shell, corresponding to a stable electronic configuration.

Covalent bonding includes many kinds of interactions, including σ-bonding, π-bonding, metal-to-metal bonding, agostic interactions, and three-center two-electron bonds.

Covalent bonding applies to two or more identical atoms, two different atoms or any other combination of different kinds of atoms. Covalent bonding that entails sharing of electrons over more than two atoms is said to be delocalized.

The frequencies where absorption occurs, as well as their relative intensities, primarily depend on the electronic and molecular structure of the sample. The frequencies will also depend on the interactions between compounds in the sample, the crystal structure in solids, supramolecular organization (polymers, inter-molecular bonds . . . ), and on several environmental factors (for instance, temperature, pressure, electromagnetic field). The absorption bands will also have a width and shape that are primarily determined by the spectral density or the density of states of the system.

Absorption bands are typically classified by the nature of the quantum mechanical change induced in the molecule or atom. Rotational bands, for instance, occur when the rotational state of a molecule is changed. Rotational bands are typically found in the microwave spectral region. Vibrational bands correspond to changes in the vibrational state of the molecule and are typically found in the infrared region. Electronic bands correspond to a change in the electronic state of an atom or molecule and are typically found in the visible and ultraviolet region. X-ray absorptions are associated with the excitation of inner shell electrons in atoms. These changes can also be combined (e.g. rotation-vibration transitions), leading to new absorption bands at the combined energy of the two changes.

The energy associated with the quantum mechanical change primarily determines the frequency of the absorption line but the frequency can be shifted by several types of interactions. Electric and magnetic fields can cause a shift. Interactions with neighboring molecules can cause shifts. For instance, absorption bands of the gas phase molecule can shift significantly when that molecule is in a liquid or solid phase and interacting more strongly with neighboring molecules.

Observed absorption bands always have a width and shape that is determined by the instrument used for the observation, the material absorbing the radiation and the physical environment of that material. Thus, the mathematical distribution of the absorption bands is a distribution profile which is characterized by mathematical parameters. A Gaussian or Lorentzian distribution are examples of distribution. Intensity and width are examples of mathematical parameters.

In the current case, each absorption band has a width extending between two extremities. The width is defined as the full width at half maximum (also labeled FHWM). Such width corresponds to the extent of a function, given by the difference between the two extreme values of the independent variable at which the dependent variable is equal to half of its maximum value. In other words, the width is defined by the two specific wavelength quantities associated to its extremities.

A sample is preferably a biological sample or any other organic matter-containing sample. These include notably the biological tissues and cells, synthetic biomaterials, vegetal species, kerogens-containing samples (bituminous sands, fossils, asphalts . . . ), and industrial materials (gums, polymers, plastics, rubbers, paints, glues . . . ).

The method for determining absorption bands comprises a step 50 of providing a measured absorption spectrum from the sample.

The measured absorption spectrum is labeled S_{MEASURED} in the remainder of the specification.

By definition, a spectrum is a set of spectroscopic data representing the evolution of an absorption quantity with regards to a wavelength quantity in a predefined range of wavelength quantity.

The absorption quantity is a quantity representative of the absorption. For instance, the intensity of the absorption or the absorbance are absorption quantities.

The wavelength quantity is a quantity representative of the wavelength. For instance, the frequency, the wavenumber or the wavelength are quantities representative of the wavelength.

The predefined range of wavelength quantity represents the wavelength domains for which data are available.

In the remainder of the description, as an example, it will be considered that the absorption quantity is absorbance and the wavelength quantity is the wavenumber. However, each feature related to absorbance can be applied to another absorption quantity. Similarly, each feature related to wavelength quantity can be applied to another wavelength quantity. Thus, in the remainder of the description, it is considered that an absorption spectrum is a set of spectroscopic data representing the evolution of absorbance with regards to wavenumber in a predefined range of wavenumber.

Absorption spectroscopy refers to spectroscopic techniques that measure the absorption of radiation, as a function of frequency or wavelength, due to its interaction with a sample. The sample absorbs energy, i.e., photons, from the radiating field. The absorption quantity varies as a function of wavelength quantity, and this variation is the absorption spectrum. Absorption spectroscopy is thus performed across the electromagnetic spectrum.

This means that the predefined range of wavenumber may, generally, be any portion of the electromagnetic spectrum, such as visible, ultraviolet or infrared.

Preferably, the predefined range of wavenumber is such that the absorption spectroscopy is an infrared spectroscopy.

More preferably, the predefined range of wavenumber extends between 7000 cm⁻¹ and 10 cm⁻¹ (this corresponds to a range of wavelength comprised between 1.5 microns and 1000 microns).

There are a wide range of experimental approaches to measuring absorption spectrum. The most common arrangement is to direct a generated beam of radiation at a sample and detect the intensity of the radiation that passes through it. The transmitted energy can be used to calculate the absorption. The source, sample arrangement and detection technique vary significantly depending on the frequency range and the purpose of the experiment.

Therefore, the step 50 of providing a measured absorption spectrum from the sample is achieved by providing any spectrum from which the absorption spectrum can be obtained.

Notably, the absorption spectrum can be derived from a transmission spectrum. Indeed, absorption and transmission spectra represent equivalent information and one can be calculated from the other through a mathematical transformation. A transmission spectrum will have its maximum intensities at wavelengths where the absorption is weakest because more light is transmitted through the sample. An absorption spectrum will have its maximum intensities at wavelengths where the absorption is strongest.

Alternatively, the absorption spectrum results from an emission spectrum. Emission is a process by which a substance releases energy in the form of electromagnetic radiation. Emission can occur at any frequency at which absorption can occur, and this allows the absorption lines to be determined from an emission spectrum. The emission spectrum will typically have a quite different intensity pattern from the absorption spectrum, though, so the two are not equivalent. The absorption spectrum can be calculated from the emission spectrum using appropriate theoretical models and additional information about the quantum mechanical states of the substance.

According to another embodiment, the absorption spectrum can be derived from a scattering or reflection spectrum. The scattering and reflection spectra of a material are influenced by both its index of refraction and its absorption spectrum. In an optical context, the absorption spectrum is typically quantified by the extinction coefficient, and the extinction and index coefficients are quantitatively related through the Kramers-Kronig relation. Therefore, the absorption spectrum can be derived from a scattering or reflection spectrum. This typically requires simplifying assumptions or models, and so the derived absorption spectrum is an approximation.

In a preferred embodiment, the step 50 of providing a measured absorption spectrum from the sample is achieved by carrying out an absorption experiment on the sample.

The most straightforward approach to carry out such an absorption spectroscopy experiment is to generate radiation with a source, measure a reference spectrum of that radiation with a detector and then re-measure the sample spectrum after placing the material of interest in between the source and detector. The two measured spectra can then be combined to determine the material's absorption spectrum. The sample spectrum alone is not sufficient to determine the absorption spectrum because it will be affected by the experimental conditions—the spectrum of the source, the absorption spectra of other materials in between the source and detector and the wavelength dependent characteristics of the detector. The reference spectrum will be affected in the same way, though, by these experimental conditions and therefore the combination yields the

absorption spectrum of the material alone. The method for determining absorption bands comprises a step 52 of providing a calculation spectrum S_{CALCULATION} which is equal to the measured absorption spectrum S_{MEASURED}.

Mathematically, this means that S_{CALCULATION}=S_{MEASURED}.

In other words, for each wavenumber of the studied spectrum, the value of the absorbance is the same in the calculation spectrum S_{CALCULATION} and in the measured absorption spectrum S_{MEASURED}.

The method for determining absorption bands also comprises a step 54 of extracting at least absorption band associated to a covalent bond present in the sample. The step 54 of extracting is carried out by using the calculation spectrum S_{CALCULATION}. In such context, the word “extract” is to be understood as meaning “model”.

The step 54 of extracting at least one absorption band optionally comprises extracting the width for each considered absorption band.

The method for determining absorption bands also comprises a step 55 of forming an absorption band population by grouping each extracted absorption band.

In other words, this means that the absorption band population is a collection of the absorption bands extracted at the step 54 of extracting.

The method for determining absorption bands also comprises a step 56 of calculating a residual spectrum S_{RESIDUAL} by removing each extracted absorption band from the calculation spectrum S_{CALCULATION}.

The method for determining also comprises a step 58 of testing whether a predefined stop criterion C_{STOP} is fulfilled by the residual spectrum S_{RESIDUAL}.

According to an embodiment, the stop criterion C_{STOP} is fulfilled when the integral of the absorbance in the residual spectrum over the predefined range of wavenumber is strictly inferior to the product of 1% with the integral of absorbance in the measured absorption spectrum over the predefined range of wavenumber. By definition, in the remainder of the description, the integral of the absorbance in a spectrum over the predefined range of wavenumber is the integral over the predefined range of wavenumber of the absorbance in a spectrum with relation to the wavenumber.

According to an embodiment, the stop criterion C_{STOP} is fulfilled when the integral of the absorbance in the residual spectrum over the predefined range of wavenumber is strictly inferior to the product of 0.1% with the integral of absorbance in the measured absorption spectrum over the predefined range of wavenumber.

According to another embodiment, the stop criterion C_{STOP} is fulfilled when the absolute value of the absorbance per wavenumber in the residual spectrum is strictly inferior to the product of 1% with the absolute value of absorbance per wavenumber in the measured absorption spectrum.

According to another embodiment, the stop criterion C_{STOP} is fulfilled when the absolute value of the absorbance per wavenumber in the residual spectrum is strictly inferior to the product of 0.1% with the absolute value of absorbance per wavenumber in the measured absorption spectrum.

According to another embodiment, the stop criterion C_{STOP} is fulfilled when the ratio between the absorbance in residual spectrum and the absorbance in the measured absorption spectrum is strictly inferior to 1% in the predefined range of wavenumber.

According to another embodiment, the stop criterion C_{STOP} is fulfilled when the ratio between the absorbance in residual spectrum and the absorbance in the measured absorption spectrum is strictly inferior to 0.1% in the predefined range of wavenumber.

According to another embodiment, the stop criterion C_{STOP} is fulfilled when any combination of the previously described stop criteria is fulfilled.

Notably, the combination of two stop criteria is of specific interest. According to the first stop criterion, the integral of the absorbance in the residual spectrum over the predefined range of wavenumber is strictly inferior to the product of 0.1% with the integral of absorbance in the measured absorption spectrum over the predefined range of wavenumber. According to the second stop criterion, the stop criterion is fulfilled when the ratio between the absorbance in residual spectrum and the absorbance in the measured absorption spectrum is strictly inferior to 1% in the predefined range of wavenumber.

If the predefined stop criterion C_{STOP} is not fulfilled, the residual spectrum S_{RESIDUAL} is used as the calculation spectrum S_{CALCULATION}. In other words, the calculation spectrum S_{CALCULATION} is set to be equal to the residual spectrum S_{RESIDUAL}.

Mathematically, this means that S_{CALCULATION}=S_{RESIDUAL}.

In other words, for each wavenumber of the studied spectrum, the value of the absorbance is the same in the calculation spectrum S_{CALCULATION} and in the residual spectrum S_{RESIDUAL}.

The extracting step 54, the forming step 55, the calculating step 56 and the testing step 58 are then iterated on the newly calculated calculation spectrum S_{CALCULATION}. The bands extracted at the end of the new iteration of the extracting step 54 are different from the previously extracted bands. This means that the bands do not share the same extremities.

If the predefined stop criterion C_{STOP} is fulfilled, the method for determining absorption bands also comprises a step 60 of outputting each extracted absorption band.

Such step 60 of outputting each extracted absorption band comprises collecting the different extracted absorption bands at each iteration and outputting data associated to the extracted absorption bands

The method for determining absorption bands benefits from all the advantages provided by an absorption technique. Notably, one of the unique advantages of spectroscopy as an analytical technique is that measurements can be made without bringing the instrument and sample into contact. Radiation that travels between a sample and an instrument will contain the spectral information, so the measurement can be made remotely. Remote spectral sensing is valuable in many situations. For example, measurements can be made in toxic or hazardous environments without placing an operator or instrument at risk. Also, sample material does not have to be brought into contact with the instrument—preventing possible cross contamination.

The method for determining absorption bands also enables to determine more accurately the covalent bonds present in the studied sample.

The method for determining absorption bands notably uses the fact that each spectrum calculated has its own bands, that is the first calculation spectrum enables to obtain a first series of bands, the second calculation spectrum enables to obtain a second series of bands and so on, each series of bands being different or completing themselves. This enables to refine the extraction of the bands at each iteration because bands with minor spectral contributions are studied together with bands of same order of magnitude in terms of spectral contribution.

Such method for determining absorption bands is a complete and automated method for extracting bands from an absorption spectrum, and notably an infrared spectrum.

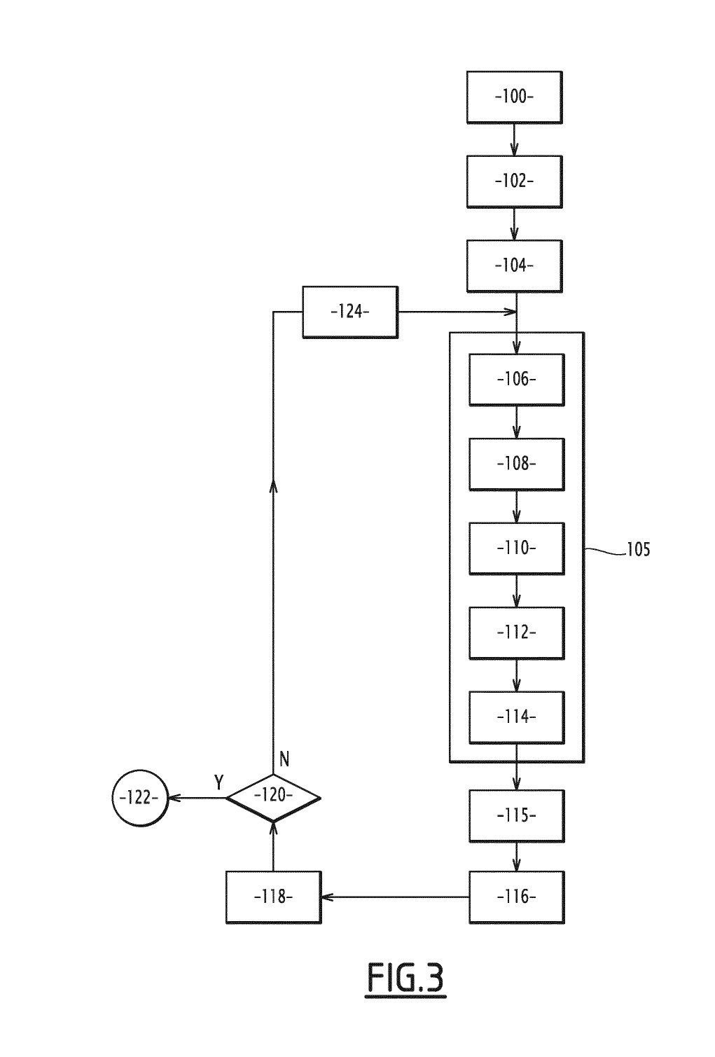

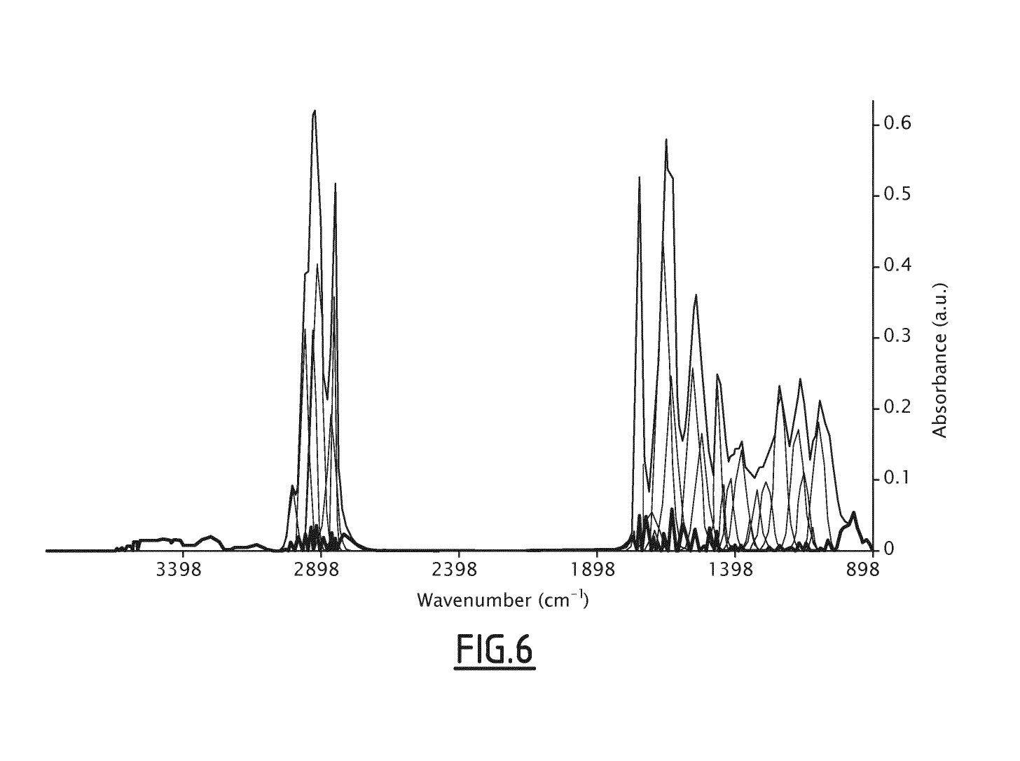

Another example of carrying out the method for determining absorption bands is now described in reference to FIGS. 3 to 6.

The method for extracting absorption bands according to the example of FIG. 3 comprises a step 100 of providing a measured absorption spectrum S_{MEASURED} from the sample.

The same remarks made for the step 50 of providing a measured absorption spectrum S_{MEASURED} from the sample also apply for the step 100 of providing a measured absorption spectrum S_{MEASURED} from the sample. Consequently, these remarks are not repeated here.

The method for extracting absorption bands according to the example of FIG. 3 also comprises a step 102 of extracting a baseline correction curve.

According to an embodiment, the baseline correction curve is determined by using at least a spectral interval in which no absorption is expected for the considered sample. Such spectral interval is, by definition, devoid of absorption in the infrared spectrum for the sample.

The presence of absorption in such spectral interval is a manifestation of the presence of the environment. Such presence perturbs the absorption measurement and should be corrected.

The baseline correction curve is determined by an interpolation taking into account the spectral intervals devoid of absorption in the infrared spectrum.

Preferably, the interpolation sets that the absorbance linked to the spectral intervals comprised between 4000 cm⁻¹ and 3700 cm⁻¹ and between 2700 cm⁻¹ and 1850 cm⁻¹ should be zero. By definition, a value is comprised between A and B if the value is superior or equal to A and if the value is inferior or equal to B.

According to a preferred embodiment, the interpolation also sets that the baseline correction curve is polynomial.

Preferably, the baseline correction curve is a polynomial of an order inferior to 4.

The method for determining absorption bands according to the example of FIG. 3 also comprises a step 104 of providing a calculation spectrum S_{CALCULATION} which is equal to the difference between the measured absorption spectrum S_{MEASURED} and the baseline correction curve.

The method for determining absorption bands according to the example of FIG. 3 also comprises a step 105 of extracting at least one absorption band from the calculation spectrum S_{CALCULATION}.

Such step 105 of extracting comprises a step of searching the absorption band(s) in the calculation spectrum, to obtain found absorption band(s), and a step of deducing values to mathematical parameters of each found absorption band, to obtain deduced parameters.

As explained in the following, such step 105 of extracting may also comprises a step chosen in the group consisting of obtaining the maxima of the calculation spectrum, calculating the first derivative of the absorption quantity with relation to the wavelength quantity, to obtain a first derivative of the calculation spectrum, calculating the second derivative of the absorption quantity with relation to the wavelength quantity, to obtain a second derivative of the calculation spectrum, and obtaining the minima of the second derivative of the calculation spectrum, the second derivative being the second derivative of the absorption quantity with relation to the wavelength quantity.

In the example of FIG. 3, the step 105 of extracting comprises five steps 106, 108, 110, 112 and 114 which are further detailed below.

The method for determining absorption bands according to the example of FIG. 3 also comprises a step 106 of searching the absorption bands in the calculation spectrum S_{CALCULATION}.

Such step 106 of searching may rely on the searching the local maxima in the calculation spectrum S_{CALCULATION}.

For each local maximum, the position of the maximum is stored in a memory. This position of the maximum is usually expressed in the unity of the wavelength quantity.

Multiple methods exist to determine the presence of a local maximum in the calculation spectrum S_{CALCULATION}.

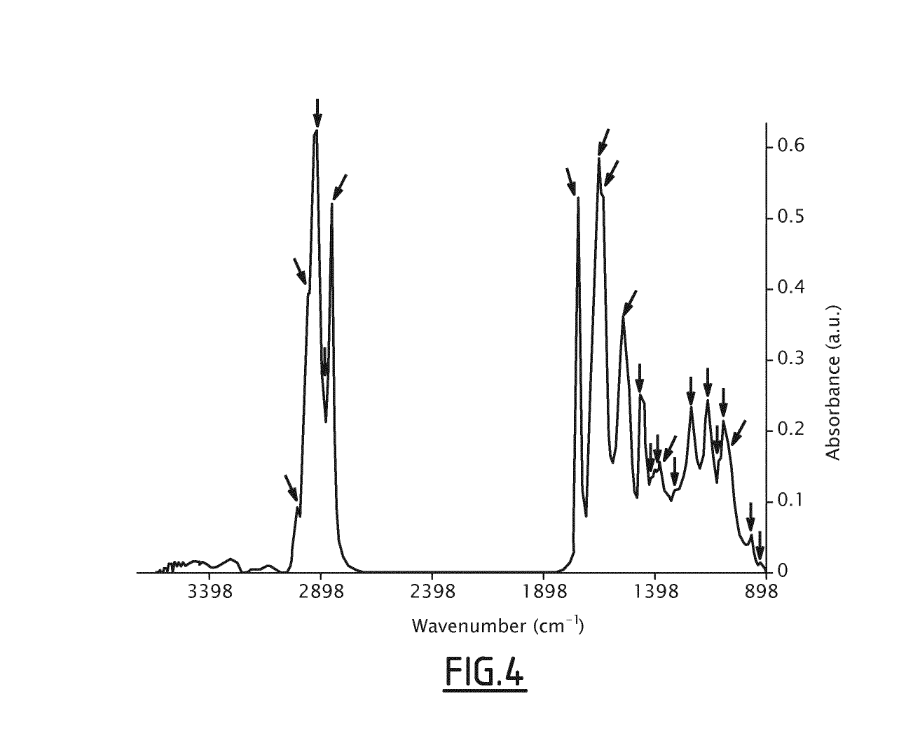

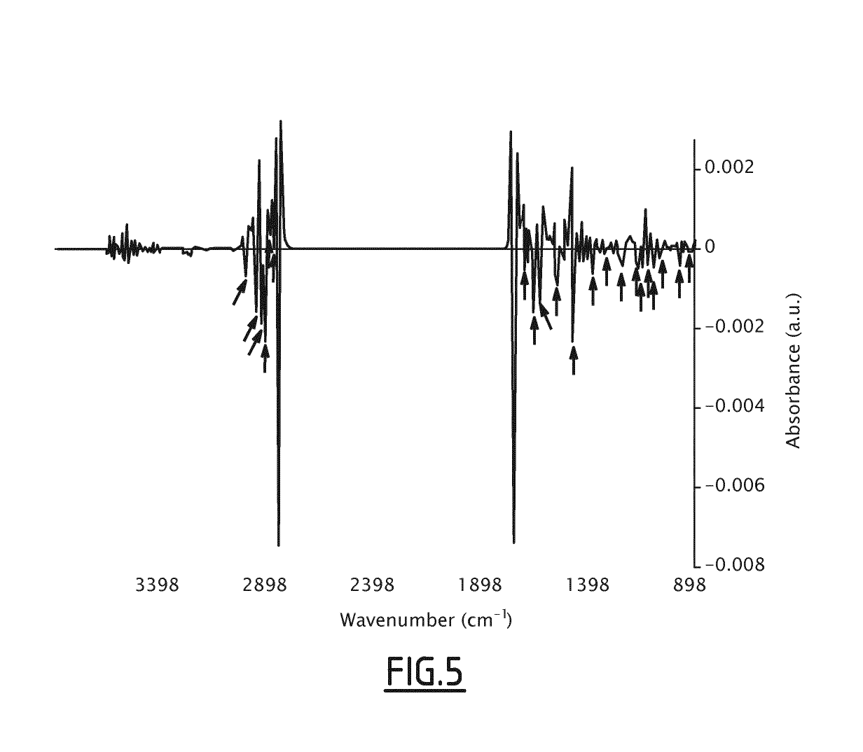

A graphic method is schematically illustrated by FIG. 4 wherein each local maximum of absorption value is shown by a respective arrow.

According to a more sophisticated embodiment, only local maximum which are superior to a threshold value of absorbance are considered. This enables to only consider the most relevant local maxima.

The method for determining absorption bands according to the example of FIG. 3 also comprises a step 108 of calculating the second derivative of the absorbance with relation to the wavenumber, to obtain a second derivative of the calculation spectrum S″_{CALCULATION}.

The method for determining absorption bands according to the example of FIG. 3 also comprises a step 110 of deducing parameters of the absorption band corresponding to the local maximum obtained at the step 106 of searching the absorption band.

For instance, the parameters deduced are chosen in the group comprising the position of the maximal absorbance in the band, the central position of the band, the position of the extremities of the band. These positions are usually expressed in the unity of the wavelength quantity.

In the remainder of the description, the position of the maximal absorbance in the band is the position of the absorption band. As an example, the width is set to a predefined value.

According to the example illustrated, such step 110 of deducing the bands is achieved thanks to the use of the second derivative of the calculation spectrum S″_{CALCULATION}.

For instance, as appears in reference to FIG. 5, the variation of evolution of the second derivative of the calculation spectrum S_{″CALCULATION} are considered as central position of bands.

More precisely, the accurate position of the central position of each band is deduced. For this, at the step 110 of deducing parameters of the absorption band, minima of absorbance in the calculation of secondary derivative spectrum S_{CALCULATION} are determined.

For each local minimum, the position of the minimum is stored in a memory. This position is usually expressed in the unity of the wavelength quantity.

Multiple methods exist to determine the presence of a local minimum in the calculation of second derivative of the calculation spectrum S_{″CALCULATION}, corresponding to a maximum in the calculation spectrum S_{CALCULATION}.

The method for extracting absorption bands according to the example of FIG. 3 also comprises a step 112 of curve-fitting each absorption band by using the deduced parameters and a Voigt profile. An absorption band has a Voigt profile, which results from the combination of two broadening mechanisms, one producing a Gaussian profile, and the other producing a Lorentzian profile. The Voigt profile is then a convolution of a Lorentzian profile and a Gaussian profile. In the remainder of the description, this means that a Gaussian proportion and a Lorentzian proportion can be defined for a Voigt profile.

For instance, according to a specific embodiment, the width of the Gaussian-Lorentzian function is set to be the deduced width and the highest value of the Gaussian-Lorentzian function is set to be equal to the value of the calculation spectrum S_{CALCULATION} at the deduced center position.

Alternatively, instead of a Voigt profile, a Gaussian profile or a Lorentzian profile may be considered.

The method for determining absorption bands according to the example of FIG. 3 also comprises a step 114 of optimizing parameters of the curve-fitted Gaussian-Lorentzian functions by using an optimization criterion.

Parameters of the curve-fitted Voigt profiles considered at the step 114 of optimizing are parameters relative to the shape of the Voigt profiles.

For instance, a parameter is the position of the center of the Gaussian-Lorentzian function, the variation of the position of the center being limited to 1 cm⁻¹ from the position of the center obtained at the curve-fitting step.

In an embodiment, a parameter is the Gaussian proportion in the Voigt profile, the variation of the Gaussian proportion being limited between 15% and 25%.

According to an embodiment, a parameter is the Lorentzian proportion in the Voigt profile, the variation of the Lorentzian proportion being limited between 75% and 85%.

Preferably, the optimization criterion is a distance between the calculation spectrum S_{CALCULATION} and the sum of each Voigt profile representative of the absorption band considered. The distance is, for instance, a root mean-square one.

The method for determining absorption bands according to the example of FIG. 3 also comprises a step 115 of forming an absorption band population.

The same remarks made for the step 55 of forming also apply for the step 115 of forming. Consequently, these remarks are not repeated here.

The method for determining absorption bands according to the example of FIG. 3 also comprises a step 116 of calculating the sum of the considered absorption bands.

The method for determining absorption bands according to the example of FIG. 3 also comprises a step 118 of calculating a residual spectrum S_{RESIDUAL} by removing the extracted absorption bands from the calculation spectrum S_{CALCULATION}. This step 118 of calculating the residual spectrum S_{RESIDUAL} is achieved thanks to the result of the step 116 of calculating the sum of the considered absorption bands.

The same remarks made for the step 56 of calculating a residual spectrum S_{RESIDUAL} by removing each extracted absorption band from the calculation spectrum S_{CALCULATION} also apply for the step 118 of calculating a residual spectrum S_{RESIDUAL} by removing each extracted absorption band from the calculation spectrum S_{CALCULATION} Consequently, these remarks are not repeated here.

The method for determining absorption bands also comprises a step 120 of testing whether a predefined stop criterion C_{STOP} is fulfilled by the residual spectrum S_{RESIDUAL}.

The same remarks made for the step 58 of testing whether a predefined stop criterion C_{STOP} is fulfilled by the residual spectrum S_{RESIDUAL} also apply for the step 120 of testing whether a predefined stop criterion C_{STOP} is fulfilled by the residual spectrum S_{RESIDUAL}. Consequently, these remarks are not repeated here.

If the predefined stop criterion C_{STOP} is not fulfilled, the method for determining absorption bands according to the example of FIG. 3 comprises setting the calculation spectrum S_{CALCULATION} to be equal to the residual spectrum S_{RESIDUAL}.

In other words, for each wavenumber of the studied spectrum, the value of the absorbance is the same in the calculation spectrum S_{CALCULATION} and in the residual spectrum S_{RESIDUAL}.

The method according to the example of FIG. 3 also comprises a step 124 of correcting each extracted absorption bands.

According to an embodiment, the step 124 of correcting comprises, for each extracted absorption band, determining the algebraic sign of the residual spectrum at the position of the considered absorption band.

According to an embodiment, the step 124 of correcting comprises for each extracted absorption band, determining the algebraic sign of the residual spectrum at the extremities of the width of the considered absorption band.

According to an embodiment, the step 124 of correcting comprises, for each extracted absorption band, analyzing the symmetry of the residual spectrum with relation to the position of the considered absorption band.

According to an embodiment, such step 124 of correcting the absorption band is achieved by using the value of the residual spectrum at the extremities of the width of the considered absorptionband. For instance, the width is enlarged if the value of the residual spectrum is positive and reduced of the residual spectrum if the value is negative.

As an example, if for a specific width, the errors occurring in the residual spectrum at the extremities of the considered width correspond to positive values, this means that the width should extend beyond the current extremities. A contrario, if the errors occurring in the residual spectrum at the extremity of a width correspond to negative values, this means that the width should be reduced with relation to the current extremities.

According to an embodiment, such step 124 of correcting each extracted absorption band is achieved by using the value of the residual spectrum at the central position of the width of the considered absorption band. For instance, the absorbance of the absorption band is increased if the value of the residual spectrum at the central position is positive and reduced if the value of the residual spectrum at the central position is negative.

Alternatively, the value of the residual spectrum considered is taken at any position which is far from the extremities of the width of the absorption band. For instance, a position which is situated at half the distance between the central position and the nearest extremity to the central position is considered as far from the extremities of the width of the absorption band.

As the arrows illustrate in FIG. 3, are then iterated the step 106 of searching the local maxima of absorbance in the calculation spectrum S_{CALCULATION}, the step 108 of calculating the second derivative of the absorbance with relation to the wavenumber, the step 110 of deducing the bands by searching local minima of absorbance corresponding to the maxima of absorbance in the calculation spectrum S_{CALCULATION}, the step 112 of curve-fitting each absorption band by using the deduced band and a Gaussian-Lorentzian function, the step 114 of optimizing parameters of the curve-fitted Gaussian-Lorentzian functions by using an optimization criterion, the step 115 of forming, the step 116 of calculating the sum of the absorption bands considered, the step 118 of calculating a residual spectrum S_{RESIDUAL} by removing each extracted absorption bands from the calculation spectrum S_{CALCULATION} and the step 120 of testing whether a predefined stop criterion C_{STOP} is fulfilled by the residual spectrum S_{RESIDUAL}.

According to a preferred embodiment, the step 114 of optimizing parameters of the curve-fitted Voigt profiles by using an optimization criterion applies to the Voigt profiles extracted at the new iteration of the step 112 of curve-fitting each absorption band by using the deduced width and a Voigt profile but also to the previous curve-fitted function. In this case, the reference spectrum is the corrected absorption spectrum.

If the predefined stop criterion C_{STOP} is fulfilled, the method for determining absorption bands also comprises a step 120 of outputting each extracted absorption band.

The same remarks made for the step 60 of outputting each extracted absorption band also apply for the step 120 of outputting each extracted absorption band. Consequently, these remarks are not repeated here.

Optionally, and preferably in case a correcting step 124 is present as in the method illustrated by FIG. 3, the stop criterion C_{STOP} is fulfilled when using the residual spectrum as the calculation spectrum to iterate the extracting step, the forming step, the calculating step and the testing step, the previously determined bands parameters are not further modified and no new band is added to the previously obtained absorption band population.

The method for determining absorption bands according to the example of FIG. 3 benefits from all the advantages provided by an absorption technique. Notably, one of the unique advantages of spectroscopy as an analytical technique is that measurements can be made without bringing the instrument and sample into contact. Radiation that travels between a sample and an instrument will contain the spectral information, so the measurement can be made remotely. Remote spectral sensing is valuable in many situations. For example, measurements can be made in toxic or hazardous environments without placing an operator or instrument at risk. Also, sample material does not have to be brought into contact with the instrument—preventing possible cross contamination.

The method for determining absorption bands also enables to determine more accurately the absorption bands associated to a covalent bond of chemical species present in the studied sample. Such method for determining absorption bands is a complete and automated method for extracting bands from an absorption spectrum, and notably an infrared spectrum.

Many applications of such method for determining absorption bands can be found. Such applications are linked to the use of absorption spectroscopy. Absorption spectroscopy is also employed in studies of molecular and atomic physics, astronomical spectroscopy and remote sensing.

In astronomy, absorption spectroscopy has been particularly important for understanding interstellar clouds and determining that some of them contain molecules. Absorption spectroscopy is also employed in the study of extrasolar planets. Detection of extrasolar planets by the transit method also measures their absorption spectrum and allows for the determination of the planet's atmospheric composition, temperature, pressure, and scale height, and hence allows also for the determination of the planet's mass.

In atomic and molecular physics, theoretical models, principally quantum mechanical models, allow for the absorption spectra of atoms and molecules to be related to other physical properties such as electronic structure, atomic or molecular mass, and molecular geometry. Therefore, measurements of the absorption spectrum are used to determine these other properties. Microwave spectroscopy, for example, allows for the determination of bond lengths and angles with high precision.

In addition, spectral measurements can be used to determine the accuracy of theoretical predictions. For example, the Lamb shift measured in the hydrogen atomic absorption spectrum was not expected to exist at the time it was measured. Its discovery spurred and guided the development of quantum electrodynamics, and measurements of the Lamb shift are now used to determine the fine-structure constant.

The method for determining absorption bands is also usable in a method for three-dimensional imaging a three-dimensional sample.

The method for three-dimensional imaging comprises a step of dividing the three-dimensional sample in a plurality of two-dimensional samples.

The method for three-dimensional imaging also comprises a step of carrying out the method for determining absorption bands to each two-dimensional sample, the method being as previously described, to obtain extracted absorption bands associated to covalent bonds for each two-dimensional sample.

The method for three-dimensional imaging also comprises a step of reconstructing the three-dimensional sample by using the extracted absorption bands for each two-dimensional sample.

In a preferred embodiment, the reconstructing step implies using a matrix in which the extracted absorption band(s) from covalent bond(s) are given for each two-dimensional sample. Such matrix may be called a “spectral matrix”.

Such method for three-dimensional imaging enables to achieve three-dimensional sample imaging at a large scale, that is, for instance, a volume of 1 cm³ for a biopsy of surgical exeresis.

The methods and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

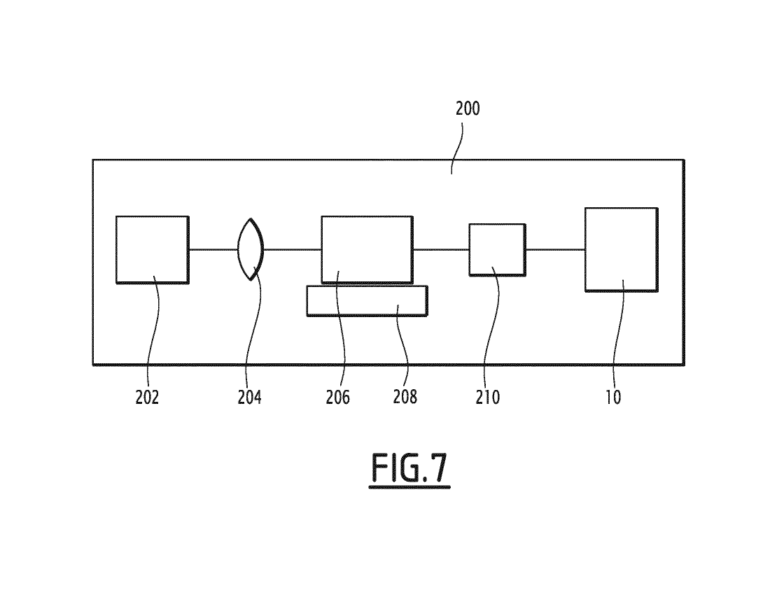

For instance, a spectrometer 200 including the system 10, as illustrated on FIG. 7, is proposed.

Such spectrometer 200 includes a radiation source 202, optics 204 to transport the radiation emitted by the radiation source 202 towards the sample 206, a sample holder 208, a detector 210.

A wide variety of radiation sources are employed in order to cover the electromagnetic spectrum. For spectroscopy, it is generally desirable for a source to cover a broad swath of wavelengths in order to measure a broad region of the absorption spectrum. Some sources inherently emit a broad spectrum. Examples of these include globars or other black body sources in the infrared, mercury lamps in the visible, ultraviolet and x-ray tubes, and various laser technologies emitting in the infrared range. One recently developed, novel source of broad spectrum radiation is synchrotron radiation which covers all of these spectral regions. Other radiation sources generate a narrow spectrum but the emission wavelength can be tuned to cover a spectral range. Examples of these include klystrons in the microwave region and lasers across the infrared, visible and ultraviolet region (though not all lasers have tunable wavelengths).

In the context of the present application, the radiation source 202 is preferably an infrared source adapted to emit wavelengths comprised in the predefined range of wavenumber. As explained above, this range may extend between 7000 cm⁻¹ and 10 cm⁻¹.

The materials of the optics 204 to transport the radiation emitted by the radiation source 202 towards the sample 206 are chosen in relation with the wavelength range of interest. Indeed, materials with relatively little absorption in the wavelength range of interest should be considered. For instance, the absorption should be inferior to 0.5%, preferably 0.01%. A too high absorption of other materials could interfere with or mask the absorption from the sample. For instance, in several wavelength ranges, absorption measurements of the sample 206 are made under vacuum or in a rare gas environment because gases in the atmosphere have interfering absorption features.

In the biological context, the optics is generally a microscope objective and mirrors.

A sample holder 208 also is made in a specific material, in other words, a material with relatively little absorption in the wavelength range of interest. For instance, the absorption should be inferior to 50%, preferably 0.01%.

The detector 210 employed to measure the radiation power will also depend on the wavelength range of interest. Most detectors are sensitive to a fairly broad spectral range and the sensor selected will often depend more on the sensitivity and noise requirements of a given measurement. Examples of detectors common in spectroscopy include heterodyne receivers in the microwave, bolometers in the millimeter-wave and infrared, mercury cadmium telluride and other cooled semiconductor detectors in the infrared, and photodiodes and photomultiplier tubes in the visible and ultraviolet.

Optionally, the spectrometer 200 also includes a spectrograph. The spectrograph is used to spatially separate the wavelengths of radiation so that the power at each wavelength can be measured independently. Such means of resolving the wavelength of the radiation in order to determine the spectrum is notably used in the case when both the source and the detector cover a broad spectral region. Indeed, as spectra can be reconstructed wavelength by wavelength, the spectrograph is not necessary.

In the present patent application, different methods are considered, these methods enabling to obtain a three-dimensional global and quantitative imaging of biological samples without any use of internal standard, reagent or label (that can be also extended to non-biological sample, better if organic). The technique used for such purpose in infrared spectroscopy, which provides a global and quantitative information about the organic functions present in the sample (and potentially some inorganic functions). The use of organic functions allows defining the presence of single molecules, families of molecules, chemical species, and biochemical parameters, which all can be reconstructed in three dimensions.

More specifically, a complete three-dimension reconstruction method from seriated two-dimension images has been reported. The method enhances previous initiatives by excluding tissue and spectra manipulations, normalization and corrections to obtain quantitative distribution of infrared absorptions in three dimensions. An automated spectral curve-fitting procedure allows transferring the wavelength-related absorption spectrum into a band-related chemical spectrum, which becomes an infrared-spectral matrix in three dimensions. Then, three-dimensional infrared imaging creates a new way to analyze tissue volumes on a micrometric scale, with quantitative and global capabilities. This breakthrough in microscopy opens the way to fully virtualized tissue analyses, which appears as the first digitized-related diagnostic and research utilization of implementable tissues in biosciences.

The embodiments and alternative embodiments considered here above can be combined to generate further embodiments of the invention.

1. Method for determining at least one absorption band in a spectrum, a spectrum being the evolution of a absorption quantity with regards to a wavelength quantity in a predefined range of wavelength quantity, the absorption quantity being a quantity representative of the absorption and the wavelength quantity being a quantity representative of the wavelength, each absorption band being a distribution profile associated to at least one covalent bond of chemical species present in a sample, the distribution profile being characterized by mathematical parameters, the method at least comprising the steps of:
providing a measured absorption spectrum from the sample,
providing a calculation spectrum which is equal to the measured absorption spectrum,
from the calculation spectrum, extracting at least one absorption band,
forming an absorption band population by grouping each extracted absorption band,
calculating a residual spectrum by removing each extracted absorption band from the calculation spectrum,
testing whether a predefined stop criterion is fulfilled by the residual spectrum,
if the stop criterion is not fulfilled, using the residual spectrum as the calculation spectrum and iterating the extracting step, the forming step, the calculating step and the testing step, the extracted absorption band(s) at the end of the iterating step being different from the previously extracted absorption band(s), and
if the stop criterion is fulfilled, outputting each extracted absorption band.

2. Method for determining at least one absorption band according to claim 1, wherein the distribution profile is chosen among a Gaussian profile, a Lorentzian profile and a Voigt profile, the Voigt profile being characterized by a Gaussian proportion and a Lorentzian proportion.

3. Method for determining at least one absorption band according to claim 1, wherein the extracting step comprises the steps of:
searching the absorption band(s) in the calculation spectrum, to obtain found absorption band(s), and
deducing values to mathematical parameters of each found absorption band, to obtain deduced parameters.

4. Method for determining at least one absorption band according to claim 3, wherein the extracting step comprises carrying out a step chosen in the group consisting of:
obtaining the maxima of the calculation spectrum,
calculating the first derivative of the absorption quantity with relation to the wavelength quantity, to obtain a first derivative of the calculation spectrum,
calculating the second derivative of the absorption quantity with relation to the wavelength quantity, to obtain a second derivative of the calculation spectrum, and
obtaining the minima of the second derivative of the calculation spectrum, the second derivative being the second derivative of the absorption quantity with relation to the wavelength quantity.

5. Method for determining at least one absorption band according to claim 3, wherein, a mathematical parameter is the position of the absorption band, the position being the wavelength quantity of the absolute maximum of absorption quantity of the considered absorption band.

6. Method for determining at least one absorption band according to claim 3, wherein, one parameter of the mathematical parameter is the width of the absorption band.

7. Method for determining at least one absorption band according to claim 1 when depending from claim 3, wherein the extracting step further comprises:
curve-fitting each absorption band by using the deduced parameters of the absorption band and a distribution profile.

8. Method for determining at least one absorption band according to claim 1, wherein the stop criterion is chosen in a selected from the group consisting of:
the integral of the absorption quantity in the residual spectrum over the predefined range of wavelength quantity is strictly inferior to the product of 1% with the integral of absorption quantity in the measured absorption spectrum over the predefined range of wavelength quantity.
the integral of the absorption quantity in the residual spectrum over the predefined range of wavelength quantity is strictly inferior to the product of 0.1% with the integral of absorption quantity in the measured absorption spectrum (over the predefined range of wavelength quantity.
the absolute value of the absorption quantity per wavelength quantity in the residual spectrum is strictly inferior to the product of 1% with the absolute value of absorption quantity per wavelength quantity in the measured absorption spectrum.
the absolute value of the absorption quantity per wavelength quantity in the residual spectrum is strictly inferior to the product of 0.1% with the absolute value of absorption quantity per wavelength quantity in the measured absorption spectrum.
the ratio between the absorption quantity in the residual spectrum and the absorption quantity in the measured absorption spectrum is strictly inferior to 1% in the predefined range of wavelength quantity,
the ratio between the absorption quantity in the residual spectrum and the absorption quantity in the measured absorption spectrum is strictly inferior to 0.1% in the predefined range of wavelength quantity, and
any combination of the previous stop criteria.

9. Method for determining at least one absorption band according to claim 1, wherein the method further comprises if the stop criterion is not fulfilled, a step of correcting each previously extracted absorption band by using the residual spectrum.

10. Method for determining at least one absorption band according to claim 9, wherein each absorption band has a position and a width with extremities, the correcting step comprising, for each extracted absorption band, determining the algebraic sign of the residual spectrum at the position of the considered absorption band and/or at the extremities of the width of the considered absorption band.

11. Method for determining at least one absorption band according to claim 9, wherein each absorption band has a position and a width with extremities, the correcting step comprising, for each extracted absorption band, analyzing the symmetry of the residual spectrum with relation to the position of each considered absorption band.

12. Method for determining at least one absorption band according to claim 9, wherein the stop criterion is fulfilled when using the residual spectrum as the calculation spectrum to iterate the extracting step, the forming step, the calculating step and the testing step, the previously determined bands parameters are not further modified and no new band is added to the previously obtained absorption band population.

13. Method for three-dimensional imaging a three-dimensional sample, the method comprising at least the step of:
dividing the three-dimensional sample in a plurality of two-dimensional samples,
carrying out the method for determining at least one absorption band to each two-dimensional sample, the method being according to claim 1, to obtain at least one absorption band associated to at least one covalent bond for each two-dimensional sample, and
reconstructing the three-dimensional sample by using the obtained absorption band for each two-dimensional sample.

14. Spectrometer comprising a radiation source optics to transport the radiation emitted by the radiation source towards the sample, a sample holder, a detector and a calculator adapted to carry out a method according to claim 1.

15. Computer program product comprising a computer readable medium, having thereon a computer program comprising program instructions, the computer program being loadable into a data-processing unit and adapted to cause execution of a method for determining according to claim 1 when the computer program is run by the data-processing unit.

16. Spectrometer comprising a radiation source, optics to transport the radiation emitted by the radiation source towards the sample, a sample holder, a detector and a calculator adapted to carry out a method for three-dimensional imaging according to claim 13.
